(19) United States
(12) Patent Application Publication
(10) Pub. No.: US 2007/0284833 A1
(43) Pub. Date: Dec. 13, 2007

(54) Electric chuck

(76) Inventors: Yung-Hsiang Lu, Chiayi (TW); Po-Cheng Su, Chiayi County (TW); Ping-Shuo Lin, Chiayi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/449,582

(22) Filed: Jun. 9, 2006

(51) Int. Cl. B23B 31/12

(52) U.S. Cl. 279/106

(57) ABSTRACT

An electric chuck includes a base, a fixed disk fixed under the base, a moving disk between the base and the fixed disk, and clamping jaws; a rotating shaft with outer threads is arranged under the fixed disk; the moving disk has a middle hole, through which the rotating shaft is threadedly passed; the clamping jaws is connected to the fixed disk and the moving disk in a movable manner; an electric motor is provided whose power is transmitted to rotate the rotating shaft; the clamping jaws will be moved to an inwardly pivoted position to hold a work piece positioned on the fixed disk when the rotating shaft is rotated to move the moving disk to its lower position; the clamping jaws will be moved to an outwardly pivoted position to release the work piece when the shaft is rotated to move the moving disk to it upper position.

### BACKGROUND OF THE INVENTION

1. Field of the Invention

The present invention relates to an electric chuck, more particularly one whose clamping jaws for work pieces are actuated to move between a fixing position and a releasing one by means of an electric motor instead of oil hydraulic/air pressure apparatuses, thus not going to cause harm to the environment.

2. Brief Description of the Prior Art

Lathes are equipped with fixing mechanisms for fixing work pieces, and the work pieces are rotated at high speed, and machined by means of cutting tools.

Clamping jaws are the major apparatus for fixing work pieces, which will be pressed against the circumferential sides of the work pieces in use. Such clamping jaws are grouped into manual and non-manual ones. Manual clamping jaws are moved between the fixing position and the releasing one with the help of tools. And, non-manual clamping jaws are actuated by means of air pressure or oil pressure therefore they will produce greater clamping force than manual ones.

However, the above clamping means for work pieces have the following disadvantages:

1. Manual clamping means can't produce effective clamping: it takes relatively much labor and time to operate a manual clamping jaw to fix a work piece, and it is impossible for a manual clamping jaw to produce the same clamping effect at different times.

2. It isn't environment friendly to use oil hydraulic apparatuses to actuate the clamping jaws: oil in oil hydraulic apparatuses is prone to pollute the environment, and difficult to dispose of, and oil hydraulic apparatuses consume electric power, and have to be maintained regularly. And, the oil container occupies relatively much space.

3. Air pressure apparatuses occupy relatively much space, and it costs more to use air pressure apparatuses.

### SUMMARY OF THE INVENTION

It is a main object of the present invention to provide an electric chuck to overcome the above-mentioned problems. The electric chuck of the present invention includes a base, a fixed disk, a moving disk, several clamping jaws, and an electric motor. The fixed disk is fixed under the base for positioning a work piece on, and there is a space between the fixed disk and the base. A rotating shaft with outer threads is arranged under the fixed disk in a rotatable manner. The moving disk is arranged between the base and the fixed disk in a movable manner, and it has a middle through hole, through which the rotating shaft is threadedly passed. The clamping jaws are connected to the fixed disk as well as the moving disk in a movable manner. Power of the electric motor is transmitted to the rotating shaft for causing rotation of the rotating shaft. The clamping jaws will be moved to an inwardly pivoted clamping position to hold a work piece positioned on the fixed disk when the rotating shaft is rotated so as to move the moving disk to its lower position. And, the clamping jaws will be moved to an outwardly pivoted releasing position to release the work piece when the rotating shaft is rotated so as to move the moving disk to its upper position. Because the chuck is equipped with the electric motor, it occupies less space and produces less noise than conventional chucks equipped with oil hydraulic apparatuses, and causes no harm to the environment.

### BRIEF DESCRIPTION OF THE DRAWINGS

The present invention will be better understood by referring to the accompanying drawings, wherein:

FIG. 1 is a sectional view of the present invention with the moving disk in its lower position and the clamping jaws in their clamping one,

FIG. 2 is an enlarged view of FIG. 3, and

FIG. 3 is a sectional view of the present invention with the moving disk in its upper position and the clamping jaws in their releasing one.

### DETAILED DESCRIPTION OF THE PREFERRED EMBODIMENTS

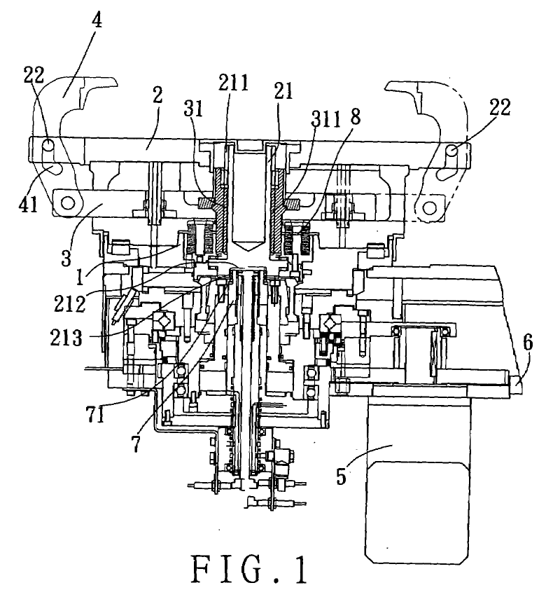

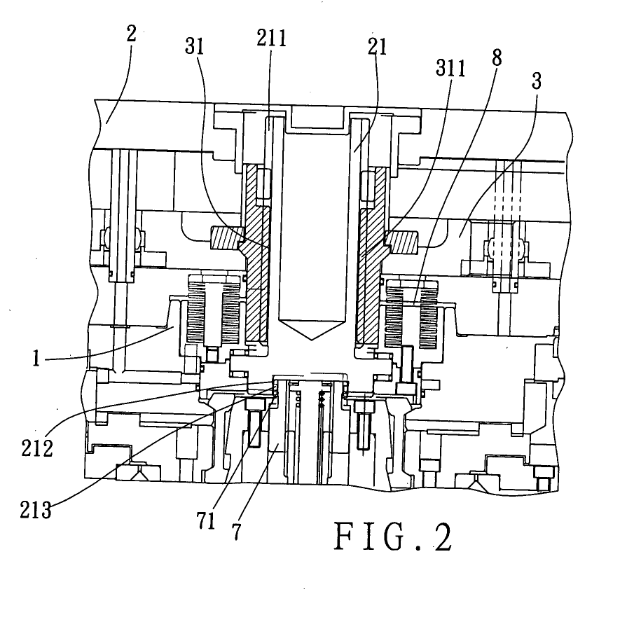

Referring to FIGS. 1 to 3, a preferred embodiment of an electric chuck of the present invention includes a base 1, a fixed disk 2, a moving disk 3, several clamping jaws 4, and an electric motor 5.

The base 1 is fixed on a machine frame or a lathe; the base 1 can be fixed on a machine frame/lathe in a releasable manner, or alternatively the base 1 can be fixed on a machine frame/lathe in a non-releasable manner; in the preferred embodiment, the base 1 is fixed on a machine frame/lathe in a releasable manner.

The fixed disk 2 is fixed, and allows a work piece (not shown) to be positioned on; the fixed disk 2 is arranged above the base 1 such that there is a space between the fixed disk 2 and the base 1; a work piece can be directly positioned on the fixed disk 2, or alternatively it can be first fixed to a fixture, which is then joined to the fixed disk 2 to fix the work piece to the fixed disk 2; a rotating shaft 21 is arranged under the fixed disk 2 or joined to the base 1 in a rotatable manner; the rotating shaft 21 has outer threads 211 on an outer circumferential side thereof.

The moving disk 3 is arranged between the base 1 and the fixed disk 2 in a movable manner; the moving disk 3 has a middle through hole 31, and the rotating shaft 21 is threadedly passed through the middle through hole 31 such that the rotating shaft 21 will cause upward and downward motion of the moving disk 3 when rotating in forward and reverse directions; more detailedly, the moving disk 3 has inner threads 311 adjacent to the middle through hole 31, and the rotating shaft 21 is passed through the middle through hole 31 with the outer threads 211 being threadedly engaged with the inner threads 311.

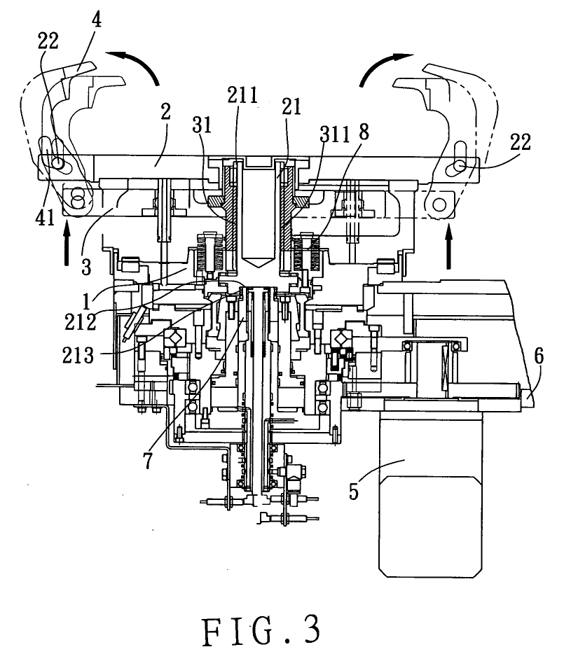

The clamping jaws 4 are connected to both the fixed disk 2 and the moving disk 3 in a movable manner; in the present preferred embodiment, the clamping jaws 4 are in the shape of an L, and are pivoted to the moving disk 3 at one end; each of the clamping jaws 4 has a guiding rail (guiding through hole in the preferred embodiment) 41 with a bending shape, and the fixed disk 2 has guiding bars 22, which are passed through respective ones of the guiding through holes 41 of the clamping jaws 4; thus, the clamping jaws 4 will be inwardly pivoted to their clamping position when the moving disk 3 is moved to its lower position, as shown in FIG. 1; the clamping jaws 4 will be outwardly pivoted to their releasing position when the moving disk 3 is moved to its upper position, as shown in FIG. 3.

The electric motor 5 is used for providing power to the rotating shaft 21 with the help of a transmission mechanism interposed between the electric motor 5 and the rotating shaft 21.

More detailedly, a transmission shaft 7 is used for transmitting motion of the electric motor 5 to the rotating shaft 21; the rotating shaft 21 has a hollow portion 212 at a lower end thereof, which is formed with teeth 213 on an inner side; the transmission shaft 7 has outer teeth 71 at an upper end; other mechanisms or elements are interposed between the transmission shaft 7 and the electric motor 5 for transmitting motion to the transmission shaft 7, and the transmission shaft 7 is joined to the rotating shaft 21 with the outer teeth 71 being engaged with the teeth 213 of the rotating shaft 21.

Furthermore, the base 1 has several coiled springs 8 sticking from it. The coiled springs 8 will be compressed by means of the moving disk 3 when the moving disk 3 is moved down; thus, the reaction force of the coiled springs 8 will ensure that the clamping jaws 4 clamp the work piece firmly.

To fix a work piece, the transmission shaft 7 is engaged with the hollow portion 212 of the rotating shaft 21, and the electric motor 5 rotates the rotating shaft 21 so as to cause downward motion of the moving disk 3; thus, the clamping jaws 4 are pulled downwards and pivoted inwards, moved to their clamping position to hold the work piece firmly in position. When the moving disk 3 is moved to its lowermost position, it will compress the coiled springs 8, and the reaction force of the coiled springs 8 will help maintain the clamping force of the clamping jaws 4 on the work piece. To release the work piece, the electric motor 5 rotates the rotating shaft 21 so as to cause upward motion of the moving disk 3; thus, the clamping jaws 4 are pushed upwards and pivoted outwards, and release the work piece.

From the above description, it can be seen that the present invention has the following advantages:

1. The present invention consumes less electricity: the clamping jaws are moved between the clamping position and the releasing one by means of the electric motor therefore it saves time and labor to use the present chuck, which can be operated more efficiently than the conventional manual apparatuses. Furthermore, the coiled springs are used to store the clamping force instead of oil hydraulic apparatuses and air pressure ones, in which the risk of hydraulic/air pressure loss exists, therefore the chuck of the present invention is more stable and safer to use.

2. It is environment friendly to use the present invention: electricity is used as the power of the chuck instead of hydraulic pressure and air pressure therefore it will reduce pollution, noise, and energy consumption to use the present invention, and the user doesn't have to change oil or carry out maintenance regularly.

3. It saves space to use the present invention: to use the chuck of the present invention, there is no need for oil hydraulic or air pressure apparatuses, which have to be used with relatively large oil containers/air storage cylinders.

What is claimed is:

1. An electric chuck, comprising
a base;
a fixed disk fixed under the base for positioning a work piece on; there being a space between the fixed disk and the base; a rotating shaft being arranged under the fixed disk in a rotatable manner; the rotating shaft having outer threads on an outer circumferential side thereof;
a moving disk, the moving disk being arranged between the base and the fixed disk in a movable manner; the moving disk having a middle through hole, through which the rotating shaft is threadedly passed;
a plurality of clamping jaws, the clamping jaws being connected to the fixed disk as well as the moving disk in a movable manner; and
an electric motor, power of the electric motor being transmitted to the rotating shaft for causing rotation of the rotating shaft;
the clamping jaws being going to be moved to an inwardly pivoted clamping position to hold a work piece positioned on the fixed disk when the rotating shaft is rotated so as to move the moving disk to one of upper and lower positions; the clamping jaws being going to be moved to an outwardly pivoted releasing position to release a work piece positioned on the fixed disk when the rotating shaft is rotated so as to move the moving disk to other one of upper and lower positions.

2. The electric chuck as recited in claim 1, wherein the base has a plurality of coiled springs sticking from it; when the moving disk is moved down, the coiled springs being going to be compressed by means of the moving disk, thus helping maintain clamping force of the clamping jaws with reaction force thereof.

3. The electric chuck as recited in claim 1, wherein each of the clamping jaws has a guiding rail with a bending shape, and the fixed disk has a plurality of guiding bars; the clamping jaws being joined to respective ones of the guiding bars at the guiding rails thereof such that the guiding rails will change position relative to the guiding bars, and the clamping jaws will be pivoted between a clamping position and a releasing one when the moving disk is moved up and down.

4. The electric chuck as recited in claim 1, wherein a transmission shaft is used for transmitting motion of the electric motor to the rotating shaft; the rotating shaft having a hollow portion at a lower end thereof; the hollow portion of the rotating shaft being formed with plural teeth on an inner side; the transmission shaft having plural outer teeth at an upper end; the transmission shaft being joined to the rotating shaft with the outer teeth being engaged with the teeth of the rotating shaft.
